(19) United States
(12) Patent Application Publication
(10) Pub. No.: US 2024/0242090 A1
(43) Pub. Date: Jul. 18, 2024

(54) METHOD AND APPARATUS WITH HYPERPARAMETER SEARCHING FOR NEURAL NETWORK LEARNING

(71) Applicant: SAMSUNG ELECTRONICS CO., LTD., Suwon-si (KR)

(72) Inventors: Sung-Jae CHO, Suwon-si (KR); Changyong SON, Suwon-si (KR); Jongseok KIM, Suwon-si (KR); Jonghoon YOON, Suwon-si (KR)

(73) Assignee: SAMSUNG ELECTRONICS CO., LTD., Suwon-si (KR)

(21) Appl. No.: 18/477,139

(22) Filed: Sep. 28, 2023

(30) Foreign Application Priority Data
Jan. 17, 2023 (KR) 10-2023-0006877

(51) Int. Cl. G06N 3/0985

(52) U.S. Cl. CPC G06N 3/0985

(57) ABSTRACT

A method of searching for hyperparameters for neural network learning includes: obtaining a preset early stop point; determining whether a current trial, among trials for searching for different combinations of hyperparameters, corresponds to a dry run trial; in response to a determination that the current trial corresponds to a dry run trial: executing learning epochs belonging to the current trial; searching for a combination of hyperparameters assigned to the current trial according to a result of the executing of the learning epochs; and changing the early stop point by based on whether an early stop with respect to a found combination of the hyperparameters is a success in each of the learning epochs.

### CROSS-REFERENCE TO RELATED APPLICATIONS

This application claims the benefit under 35 USC § 119(a) of Korean Patent Application No. 10-2023-0006877, filed on Jan. 17, 2023, in the Korean Intellectual Property Office, the entire disclosure of which is incorporated herein by reference for all purposes.

### BACKGROUND

### 1. Field

The following disclosure relates to a method and apparatus with hyperparameter searching for neural network learning.

### 2. Description of Related Art

Various parameters may be used when training an artificial intelligence (AI) algorithm, and optimal performance may be secured through parameter tuning. However, due to the huge size of parameter space used for tuning, and their varying roles in different types of neural networks and expected datasets, it has been necessary to rely on manual heuristic methods applied by domain experts or AI experts with the experience and knowledge to determine appropriate parameters to be used for parameter tuning.

Automated hyperparameter optimization (HPO) technologies that may replace such manual heuristic methods are being developed. With HPO technologies, algorithms propose parameters to reach a target objective by repeating various training-related experiments. HPO technologies do not require domain knowledge and/or experience since the algorithms propose optimized parameters in the parameter space, but due to the need for repeating many experiments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of searching for hyperparameters for neural network learning includes: obtaining a preset early stop point; determining whether a current trial, among trials for searching for different combinations of hyperparameters, corresponds to a dry run trial; in response to a determination that the current trial corresponds to a dry run trial: executing learning epochs belonging to the current trial; searching for a combination of hyperparameters assigned to the current trial according to a result of the executing of the learning epochs; and changing the early stop point by based on whether an early stop with respect to a found combination of the hyperparameters is a success in each of the learning epochs.

The method may further include: in response to a determination that the current trial does not correspond to a dry run trial, executing a portion of epochs according to the early stop point among the learning epochs belonging to the current trial; and searching for a combination of hyperparameters assigned to the current trial according to a result of the executing of the portion of learning epochs.

The changing of the early stop point may include: simulating the early stop in each of the learning epochs; and adjusting the early stop point based on a result of the simulating.

The adjusting of the early stop point may include: increasing a safeguard gap for adjusting the early stop point by a safety step for each dry run trial; and when an early stop point adjusted by the increased safeguard step is less than a safeguard gap corresponding to the preset early stop point, setting the adjusted early stop point to an adjusted safeguard gap corresponding to the adjusted early stop point.

The adjusting of the early stop point may include adjusting the early stop point based on a difference between a first learning epoch that is a success with respect to the early stop among the learning epochs and the preset early stop point.

The adjusting of the early stop point may include adjusting the early stop point by shifting the preset early stop point according to a value obtained by applying a weight to the difference.

The adjusting of the early stop point may include: based on the result of the simulating being a success with respect to the early stop, decreasing the early stop point by a safety step that is a step for increasing a safe gap for each dry run trial; and in response to a verification that the result of the simulating is a failure of the early stop, increasing the early stop point by the safeguard step.

The safeguard step may be determined to be the greater of 1 and a value obtained by dividing the number of learning epochs by a learning reference value.

The decreasing of the early stop point by the safety step may include adjusting the decreased early stop point to satisfy a condition that the decreased early stop point is set behind a last learning epoch that is a failure with respect to the early stop among the learning epochs.

The increasing of the early stop point by the safety step may include adjusting the increased early stop point to satisfy a condition that the increased early stop point is set before a first learning epoch that is a success of the early stop among the learning epochs.

The adjusting of the early stop point may include, in response to a verification that the result of the simulating is a failure of the early stop, adjusting the early stop point to a setting subsequent to a last learning epoch that is a failure with respect to the early stop among the learning epochs.

The dry run trial may be determined at a random interval or a regular interval for the trials.

A non-transitory computer-readable storage medium may store instructions that, when executed by a processor, cause the processor to perform any of the methods.

In another general aspect, an apparatus for searching for hyperparameters for neural network learning includes: one or more processors; a memory storing one or more instructions configured to cause the one or more processors to: obtain a preset early stop point, determine whether a current trial, among trials for searching for different combinations of hyperparameters, corresponds to a dry run trial, in response to a determination that the current trial corresponds to a dry run trial: execute learning epochs belonging to the current trial, search for a combination of hyperparameters assigned to the current trial according to a result of the executing of the learning epochs, and change the early stop point by verifying whether an early stop by a found combination of hyperparameters is a success in each of the learning epochs.

The instructions may be further configured to cause the one or more processors to: in response to a determination that the current trial does not correspond to a dry run trial: execute a portion of epochs according to the early stop point among the learning epochs belonging to the current trial, and search for a combination of hyperparameters assigned to the current trial according to a result of the executing of the portion of learning epochs.

The instructions may be further configured to cause the one or more processors to simulate the early stop in each of the learning epochs, and adjust the early stop point based on a result of the simulating.

The instructions may be further configured to cause the one or more processors to adjust the early stop point by shifting the preset early stop point reflecting a value obtained by applying a weight to a difference between a first learning epoch that is a success of the early stop among the learning epochs and the preset early stop point.

The instructions may be further configured to cause the one or more processors to: in response to a verification that the result of the simulating is a success of the early stop, decrease the early stop point by a safety step that is a step for increasing a safeguard gap for each dry run trial, and in response to a verification that the result of the simulating is a failure of the early stop, increase the early stop point by the safeguard step, wherein the safeguard step may be determined to be a greater of 1 and a value obtained by dividing the number of learning epochs by a learning reference value.

The instructions may be further configured to cause the one or more processors to: adjust the decreased early stop point to satisfy a condition that the decreased early stop point is set behind a last learning epoch that is a failure of the early stop among the learning epochs, and adjust the increased early stop point to satisfy a condition that the increased early stop point is set before a first learning epoch that is a success of the early stop among the learning epochs.

The instructions may be further configured to cause the one or more processors to, in response to a verification that the result of the simulating is a failure of the early stop, adjust the early stop point to a setting subsequent to a last learning epoch that is a failure of the early stop among the learning epochs.

Other features and aspects will be apparent from the following detailed description, the drawings, and the claims.

### BRIEF DESCRIPTION OF THE DRAWINGS

FIGS. 1A and 1B illustrate an early stop related to neural network learning, according to one or more embodiments.

FIG. 2 illustrates a general process of optimizing hyperparameters for neural network modeling, according to one or more embodiments.

FIG. 3 illustrates an example method of searching for hyperparameters, according to one or more embodiments.

FIG. 4 illustrates an example method of searching for hyperparameters, according to one or more embodiments.

FIGS. 5A and 5B illustrate an example of performing a dry run trial, according to one or more embodiments.

FIG. 6 illustrates an example of adjusting an early stop timepoint based on a simulation result in a dry run trial, according to one or more embodiments.

FIG. 7 illustrates an example method of searching for hyperparameters, according to one or more embodiments.

FIGS. 8 and 9 illustrate examples of performing an early stop algorithm, according to one or more embodiments.

FIG. 10 illustrates an example of an apparatus for searching for hyperparameters, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may ” herein with respect to an example or embodiment, e.g., as to what an example or embodiment may include or implement, means that at least one example or embodiment exists where such a feature is included or implemented, while all examples are not limited thereto.

HPO technologies may use significant resources for parameter optimization. To supplement these methods, when the result of a final HPO experiment are expected to be poor, an early stop technique for stopping the experiment in the middle rather than performing the experiment to the end may be used.

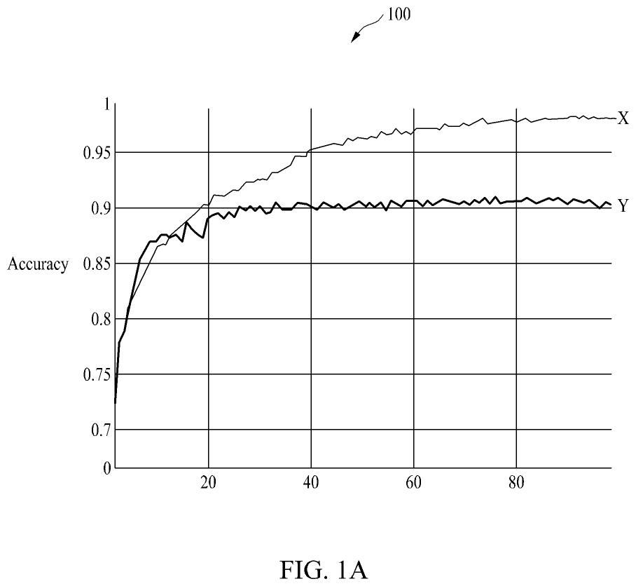

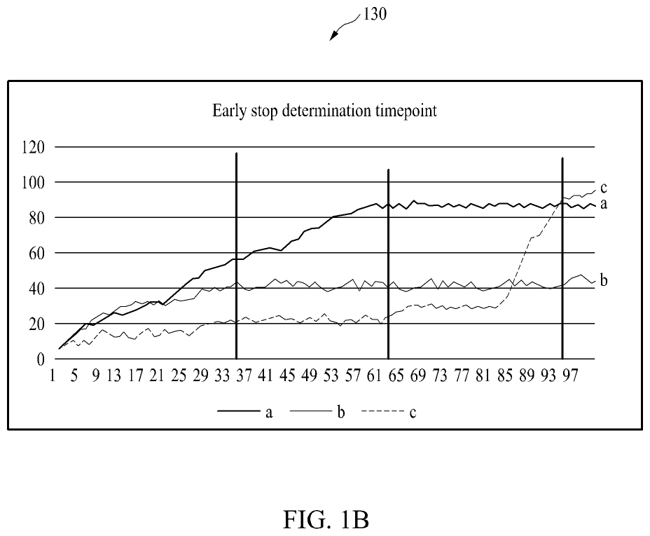

FIGS. 1A and 1B illustrate an early stop related to neural network learning, according to one or more embodiments. Referring to FIG. 1A, a graph 100 shows the need for an early stop during neural network learning.

Prior to later description of an early stop, a neural network will be briefly described.

A neural network may be trained based with deep learning, and then the trained neural network may perform inference for the purpose provided by training by mapping, to each other, input data and output data that are in a nonlinear relationship. Deep learning may correspond to machine learning techniques for solving a problem such as image and/or speech recognition from a big data set. Deep learning may be construed as an optimization problem-solving process for finding a point at which energy is minimized while training a neural network using prepared training data. Through supervised or unsupervised deep learning, a structure of the neural network or a weight (set of node weights) corresponding to a neural network model may be obtained, and the input data and the output data may be mapped to each other by the neural network having the obtained weight. When a width and depth of the neural network are sufficiently large, the neural network may have a capacity sufficient to implement an arbitrary function. When the neural network learns a sufficiently great amount of training data through a suitable training process, optimal performance may be achieved.

The neural network may include, for example, a deep neural network (DNN) including a plurality of layers. The DNN may be or may include, for example, a fully connected network (FCN), a convolutional neural network (CNN), or a recurrent neural network (RNN), to name some examples. For example, a portion of the layers in the DNN may correspond to a CNN, and another portion of the layers may correspond to an FCN. In this example, the CNN may be referred to as a convolutional layer, and the FCN may be referred to as a fully connected layer.

Hyperparameter optimization (HPO) technologies may propose optimal hyperparameters in the parameter space of a neural network by repeating neural network learning a large number of times. Parameters of a neural network may correspond to values (e.g., weights, biases, etc.) estimated inside the neural network from input data. On the other hand, hyperparameters may correspond to values set for neural network modeling. The hyperparameters may include, for example, various values related to a structure of a neural network, such as a configuration of nodes for deep learning of the neural network, a learning rate of the neural network, a momentum, a batch size, a loss, the number of hidden layers included in the neural network, and the number of nodes for each hidden layer of the neural network; the hyperparameters are not limited thereto and others may be searched for. The hyperparameters may also be referred to as “objective metrics”.

As shown in the graph 100, the accuracy of a neural network as a function of hyperparameter X and as a function of a hyperparameter Y may increase in proportion as the learning (training) count of the neural network increases, and then generally stop increasing as the learning count exceeds a predetermined count.

The graph 100 shows that the rate of increase in accuracy of the hyperparameter X does not change significantly as the learning count exceeds “70”, and the rate of increase in accuracy of the hyperparameter Y does not change significantly as the learning count exceeds “30”.

As described above, when learning is repeated up to a predetermined learning count limit (e.g., “100”), the rate of increase in accuracy may not change significantly after some count before the predetermined count limit, and thus the learning time may longer than necessary and utilization of resources may be wasted during the latter part of the learning time. When the accuracy does not significantly increase even as learning is repeated, the learning time may in theory be shortened and the wasteful utilization of resources may decrease by stopping learning in the middle (e.g., at “30” or “70”) rather than performing the learning to the end (e.g., at “100”). It may be beneficial to determine when to perform an early stop (“the early-stop timepoint”) during the repetition of learning.

Referring to FIG. 1B, a graph 130 shows the relationship between accuracy and early-stop timepoint according to the learning time for hyperparameters a, b, and c.

As described above, it may be important to determine a start timepoint for a processing of determining an early-stop timepoint. For example, when an early stop is performed at the early half of an experiment, although the total experiment time may be reduced, it may result in abandoning the obtainment of hyperparameters too early to secure hyperparameters that provide high performance. On the other hand, when an early stop is performed at the late half of the experiment, the accuracy of predicting an early stop may increase, but the experiment time may also increase. Thus, it may be difficult to obtain a beneficial balance between time and/or utilization of resources.

In addition, the early-stop timepoint may vary depending on, for example, a hyperparameter optimization algorithm and/or a parameter space. That is, different hyperparameters and different hyperparameter optimization algorithms may have different ideal early-stop time timepoints. Also, it may not be desirable for a person to determine an early-stop timepoint because it requires another domain knowledge.

For example, in the graph 130, the rate of increase in accuracy of a hyperparameter “a” decreases (approaches “0”) at a point at which the learning count is “61”, and thus, it is desirable to determine the point at which the learning count is “61” to be an early-stop timepoint. Similarly, it may be desirable, for a hyperparameter “b”, to determine a point at which the learning count is “33” to be an early-stop timepoint, and it may be desirable, for a hyperparameter “c”, to determine a point at which the learning count is “93” to be an early-stop timepoint. As described above, the optimal early-stop timepoint may differ for each hyperparameter, and thus, it may not be desirable to determine an early-stop timepoint in consideration of only one hyperparameter.

In an example, by adaptively adjusting or determining an early-stop timepoint and determining the early-stop timepoint based on multiple hyperparameters rather than one hyperparameter, in the training process of the neural network, the early-stop timepoint may be optimized, and the efficiency of using resources may also improve.

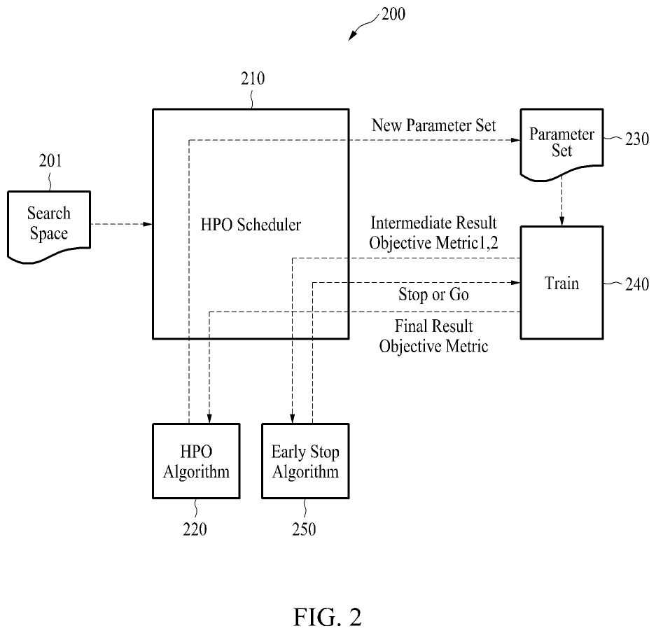

FIG. 2 illustrates a general process of optimizing hyperparameters for neural network modeling, according to one or more embodiments. Referring to FIG. 2, an apparatus for optimizing a hyperparameter (“optimization apparatus”) 200 is shown.

A scheduler 210 of the optimization apparatus 200 may perform hyperparameter optimization (HPO) by searching for optimal hyperparameters in a search space 201.

The scheduler 210 may select a hyperparameter set 230 (in the search space 201) to be used for a next iteration of training a neural network, and may select the hyperparameter set 230 based on a final result of a previous iteration of training the neural network obtained through an HPO algorithm 220. A training device 240 may train the neural network using the selected hyperparameter set 230. Here, the training device 240 may be, for example, in the form of program code (machine-executable instructions), but is not limited thereto.

Since previous learning results may not exist during the initial execution of learning, the HPO algorithm 220 may on a first iteration, transfer a randomly generated hyperparameter set 230 to the training device 240.

Since whether to perform an early stop is to be determined in the middle of the process of iterative learning, the scheduler 210 may transfer an intermediate result of learning, obtained through the training device 240, to the early-stop algorithm 250. Here, the intermediate result may be, for example, hyperparameter(s) such as a first objective metric (Objective Metric 1) and a second objective metric (Objective Metric 2).

When the early-stop algorithm determines that the intermediate result satisfies an early-stop condition, the early-stop algorithm 250 may determine to stop continued iteration of the current learning, and may transmit information about an early-stop timepoint of the learning to the training device 240. In this case, the early-stop algorithm 250 may allow a user to contribute to determining the early-stop timepoint, or may automatically determine the early-stop timepoint. The early-stop timepoint may not change once determined, and may be maintained as it is during neural network learning.

When the transferred intermediate result does not satisfy the early-stop condition, the early-stop algorithm 250 may transmit a determination to continue with another iteration of the current learning to the training device 240. The training device 240 may transmit an objective metric corresponding to the final result of learning to the HPO algorithm 220 after the current learning is completed. In this case, the objective metric corresponding to the final result of learning may be, for example, one hyperparameter or a hyperparameter set. The HPO algorithm 220 may perform hyperparameter optimization by the objective metric(s) corresponding to the final result.

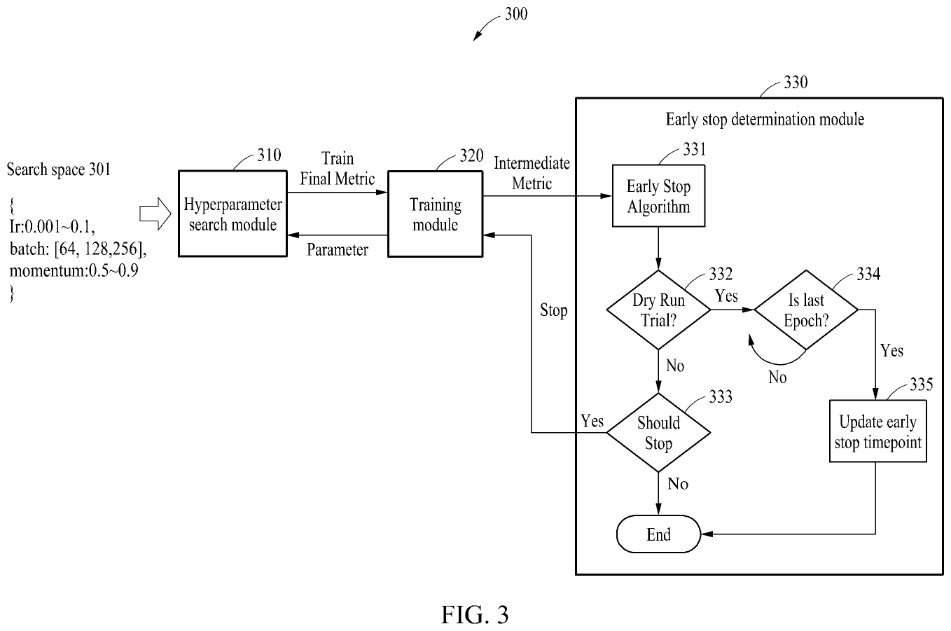

FIG. 3 illustrates an example method of searching for hyperparameters, according to one or more embodiments. Referring to FIG. 3, an apparatus for searching for hyperparameters (hereinafter, the “search apparatus”) 300 may include a hyperparameter search module 310, a training module 320, and an early-stop determination module 330.

In the example of FIG. 3, the search apparatus 300 is illustrated as including a plurality of components to describe its respective functions separately. Accordingly, when a product is actually implemented, the search apparatus 300 may include all the plurality of components or process a portion of the components in at least one processor.

The hyperparameter search module 310 may search for hyperparameters in a search space 301. The search space 301 may include, for example, a combination of various hyperparameters related to the structure of the neural network, such as a learning rate lr of the neural network, a momentum, and a batch size.

For one search iteration (of many), the hyperparameter search module 310 may select, within the search space 301, a hyperparameter set to be used for a next training, and may select the hyperparameter set based on a final result of a previous training of the neural network by the training module 320, or, in the case of an initial execution of learning, the hyperparameter module 310 may transfer an initial randomly generated hyperparameter set to the training module 320.

The training module 320 may then train the neural network using the hyperparameter set selected by the hyperparameter search module 310. Here, the training module 320 may be, for example, in the form of program code (processor executable instructions), but is not necessarily limited thereto.

Since whether to perform an early stop is to be determined in the middle of the process of repeating learning, the training module 320 may transfer an intermediate result of learning to the early-stop determination module 330. Here, the intermediate result may be, for example, multiple hyperparameters such as a first objective metric and a second objective metric.

The early-stop determination module 330 may change the early-stop timepoint through operations 331 to 335. In a hyperparameter search, the early-stop timepoint may play a role in adjusting a trade-off between learning accuracy and time. However, if it is difficult or impossible to change the early-stop timepoint (once determined) until the entire search ends, hyperparameter optimization may become impractical.

In an example, the early-stop timepoint may be optimized by adding a dry run trial for simulating whether to perform an early stop, among a plurality of trials for neural network learning, and adjusting the early-stop timepoint based on a result of simulating the early stop in each of learning epochs of the dry run trial. As used herein, “dry trial run” (and similar phrases) refers to a mock attempt (trial) or an experimental attempt (trial).

The search apparatus 300 may simulate whether to perform an early stop during the dry run trial process, and may not practically perform an early stop. The search apparatus 300 may perform a simulation of an early stop for each of the learning epochs included in the dry run trial so that the early-stop timepoint may be determined more accurately (i.e., fine-tuned). The search apparatus 300 may optimize the early-stop timepoint by adjusting the early-stop timepoint to be suitable for each neural network (or neural network model) through a dry run trial that does not practically perform an early stop.

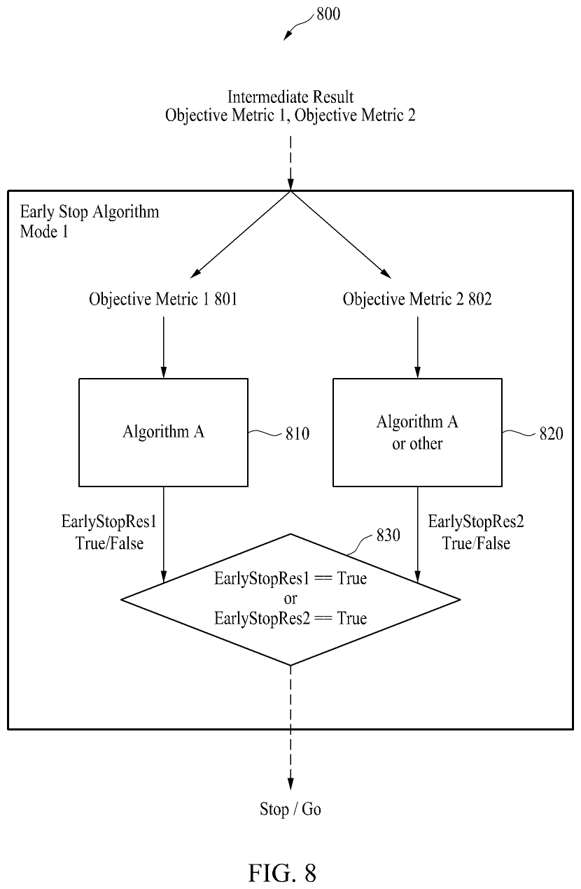

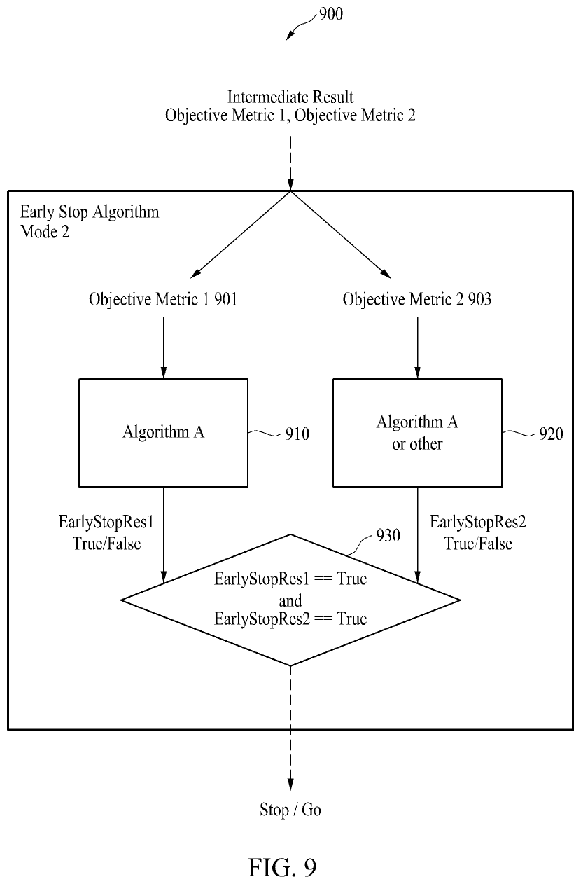

In operation 331, the early-stop determination module 330 may drive an early-stop algorithm. The early-stop algorithm may be, for example, an early-stop algorithm of FIG. 8 and/or FIG. 9, but is not limited thereto.

In operation 332, the early-stop determination module 330 may determine whether the current trial among the plurality of trials of the neural network corresponds to a dry run trial.

When it is determined in operation 332 that the current trial does not correspond to a dry run trial, the early-stop determination module 330 may determine whether the current trial is an early-stop timepoint for stopping learning, in operation 333. When it is determined in operation 333 that the current trial is an early-stop timepoint, the early-stop determination module 330 may transmit a signal to the training module 320 to instruct an early stop of the learning.

When it is determined in operation 333 that the current trial is not at an early-stop timepoint for stopping learning, the early-stop determination module 330 may execute learning epochs.

When it is determined in operation 332 that the current trial corresponds to a dry run trial, the early-stop determination module 330 may determine whether a last learning epoch of the dry run trial is reached, in operation 334.

When it is determined in operation 334 that the last learning epoch of the dry run trial is reached, in operation 335, the early-stop determination module 330 may determine whether the early-stop timepoint needs to be changed and update the early-stop timepoint. For example, the early-stop determination module 330 may change the early-stop timepoint by searching for a combination of hyperparameters assigned to the current trial according to a result of executing the learning epochs belonging to the current trial, and verifying whether an early stop is a success in each of the learning epochs.

When it is determined in operation 334 that the last learning epoch of the dry run trial is not reached, the early-stop determination module 330 may execute a next learning epoch and determine whether the last learning epoch is reached, in operation 334. The early-stop determination module 330 may execute a next learning epoch until the last learning epoch is reached. Method of searching for hyperparameters by the search apparatus 300 are described in further detail with reference to the following drawings.

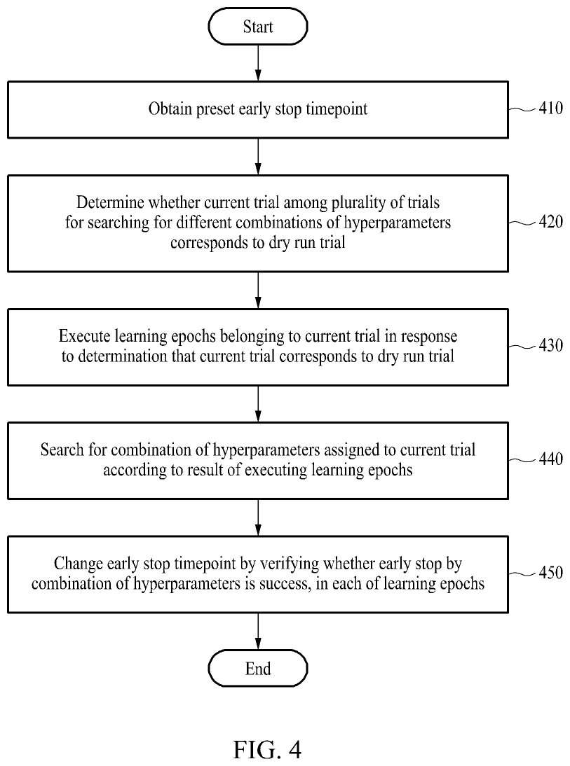

FIG. 4 illustrates an example method of searching for hyperparameters, according to one or more embodiments.

Referring to FIG. 4, a search apparatus may change an early-stop timepoint through operations 410 to 450.

In operation 410, the search apparatus obtains a preset early-stop timepoint. The preset early-stop timepoint may be, for example, an early-stop timepoint set in a previous trial or an initial early-stop timepoint set as a default, but is not limited thereto.

In operation 420, the search apparatus determines whether a current trial among a plurality of trials for searching for different combinations of hyperparameters corresponds to a dry run trial. For example, the dry run trial may be determined at a random interval or a regular interval for the plurality of trials.

In response to a determination in operation 420 that the current trial corresponds to a dry run trial, the search apparatus may change the early-stop timepoint through operations 430 to 450.

In operation 430, the search apparatus executes learning epochs belonging to the current trial.

In operation 440, the search apparatus searches for a combination of hyperparameters assigned to the current trial according to a result of executing the learning epochs in operation 430.

In operation 450, the search apparatus changes the early-stop timepoint by verifying, in each of the learning epochs, whether an early stop by the combination of hyperparameters found in operation 440 is a success.

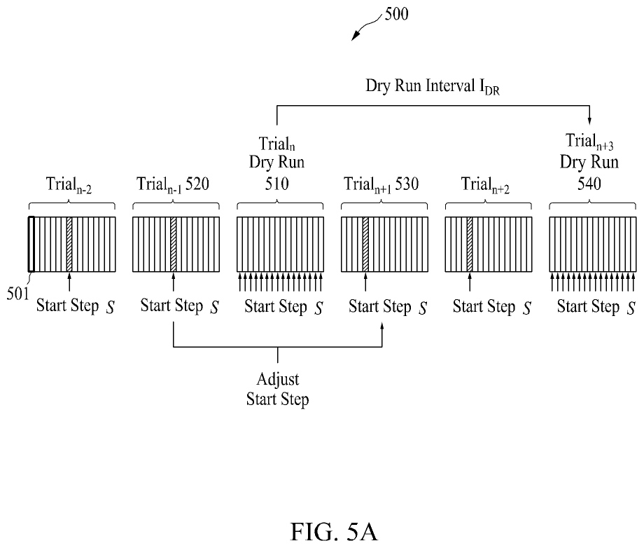

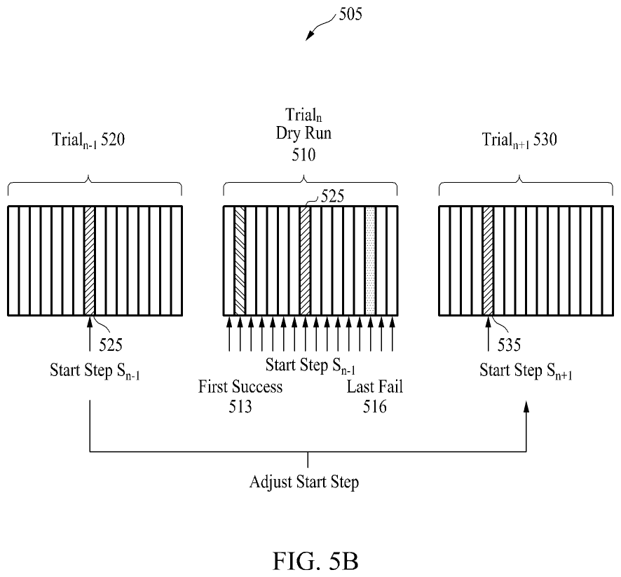

In operation 450, the search apparatus may simulate an early stop in each of the learning epochs through the dry run trial, and adjust the early-stop timepoint based on a result of the simulation. The process of performing a dry run trial by the search apparatus is described reference to FIG. 5.

The search apparatus may adjust the early-stop timepoint by increasing or decreasing a safety step of the early-stop timepoint according to whether the simulation result is a success.

For example, when it is determined that the result of the simulation is a success for the early stop, the search apparatus may advance and shorten the early-stop timepoint. When it is determined that the result of the simulation is a failure of the early stop, the search apparatus may postpone and extend the early-stop timepoint.

The search apparatus may simply increase or decrease early-stop timepoint by a safety step depending on whether the simulation result of the early stop is a success or a failure, but may adjust the early-stop timepoint so that the early-stop timepoint, when increased according to a failure, may not be positioned behind a first learning epoch that is a success of the early stop.

As described below, the safety step may be determined, for example, to be a greater of (i) a value obtained by dividing the number of learning epochs by a learning reference value and (ii) “1”. Here, the learning reference value may be, for example, “100” epochs, but is not limited thereto.

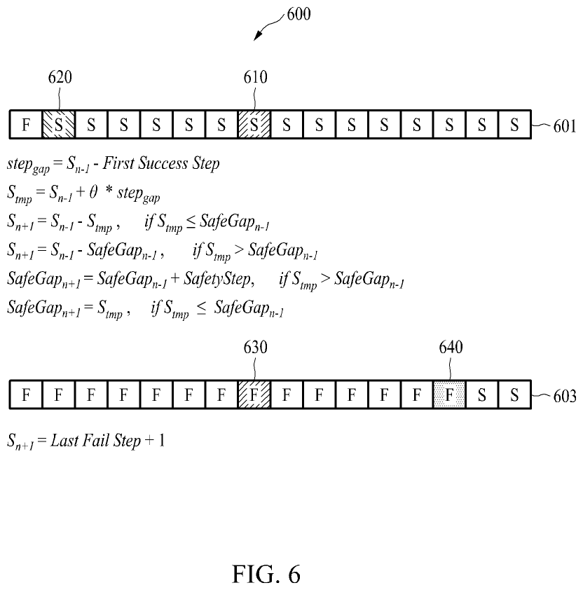

Alternatively, the search apparatus may adjust the early-stop timepoint in consideration of a difference between a first learning epoch that is a success of the early stop (among the learning epochs) and the preset early-stop timepoint. The search apparatus may adjust the early-stop timepoint by shifting the preset early-stop timepoint according to a value obtained by applying a weight to the difference. The example of adjusting the early-stop timepoint based on the simulation result in the dry run trial is described with reference to FIG. 6.

FIGS. 5A and 5B illustrate an example of performing a dry run trial, according to one or more embodiments. Referring to FIG. 5A, a diagram 500 shows a process of performing a dry run trial, and referring to FIG. 5B, a diagram 505 shows a process of adjusting an early-stop timepoint through the dry run trial.

In FIGS. 5A and 5B, one trial denotes learning that is repeatedly performed by one combination of hyperparameters, and multiple learning epochs 501 may be performed in one trial. The learning epochs 501 may be understood as the iterations of learning performed by one combination of hyperparameters. Start Step S may denote (a position of) a learning epoch corresponding to a start timepoint of an early stop.

In FIG. 5B, “First Success” denotes (a position of) a first learning epoch that is a success of the early stop among the learning epochs of a dry run trial 510. “Last Fail” denotes (a position of) a last learning epoch that is a failure of the early stop among the learning epochs of the dry run trial 510.

The search apparatus may adaptively change a learning epoch S corresponding to the start timepoint of the early stop (“the early-stop timepoint”) according to the process of performing hyperparameter optimization, in a plurality of trials for searching for different combinations of hyperparameters (e.g., an (n−2)-th trial Trialₙ₋₂, an (n−1)-th trial Trialₙ₋₁ 520, an n-th trial Trialₙ 510, an (n+1)-th trial Trialₙ₊₁530, an (n+2)-th trial Trialₙ₊₂, and an (n+3)-th trial Trialₙ₊₃540). To this end, the search apparatus may add dry run trials 510 and 540 to the middles of respective learning trials for hyperparameter optimization.

The dry run trials 510 and 540 may correspond to a process of simulating whether to perform an early stop for every learning epoch of the corresponding trial, without practically reflecting an early stop. I_{DR} may be an interval between the n-th trial 510 corresponding to a first dry run trial and the (n+3)-th trial 540 corresponding to a second dry run trial. At this time, the interval I_{DR} between the dry run trials 510 and 540 may be determined to be a random interval or a regular interval for the trials.

In each of the dry run trials 510 and 540, the search apparatus may determine an optimal early-stop timepoint after completing the simulation on all the learning epochs, thereby updating the preset early-stop timepoint.

For example, the preset early-stop timepoint in the (n−1)-th trial 520 may be a learning epoch 525 of “8” (the 8th). When it is determined that the current n-th trial 510 corresponds to a dry run trial, the search apparatus may simulate an early stop for each learning epoch with respect to a total of “16” learning epochs that belong to the current n-th trial 510.

The search apparatus may change the early-stop timepoint to a learning epoch that is a success with respect to the early stop, according to the simulation result on all the “16” learning epochs belonging to the current n-th trial 510 that is the dry run trial. More specifically, the search apparatus may search for a combination of hyperparameters assigned to the current n-th trial 510 according to a result of executing the learning epochs. The search apparatus may change the early-stop timepoint by verifying whether an early stop by a combination of hyperparameters is a success for each of the “16” learning epochs. The search apparatus may change an early-stop timepoint in the (n+1)-th trial 530 subsequent to the n-th trial 510, reflecting the result of simulating the early stop in the n-th trial 510 that is the dry run trial. The search apparatus may change the preset early-stop timepoint by determining whether to perform an early stop for every step (or every epoch) without an early stop in the dry run trial process and by determining an optimal start timepoint after all steps (or all epochs) are completed.

According to the simulation result, the search apparatus may adjust or change the preset early-stop timepoint in a trial (e.g., the (n−1)-th trial 520) prior to the dry run trial (e.g., the n-th trial 510). In this case, the adjusted early-stop timepoint may be applied to a trial (e.g., the (n+1)-th trial 530) subsequent to the dry run trial (e.g., the n-th trial 510).

For example, the search apparatus may adjust the preset early-stop timepoint (e.g., the learning epoch “8” 525) to the learning epoch “5” in the (n−1)-th trial 520 according to a value obtained by applying a predetermined weight to a difference (“6”) between the learning epoch “8” 525 that is the preset early-stop timepoint and the learning epoch “2” 513, wherein the learning epoch “2” 513 may be the first learning epoch (First Success) that is a success in the early stop in the n-th trial 510 that is the dry run trial. The early-stop timepoint adjusted to the learning epoch “5” 535 may be applied to the (n+1)-th trial 530.

The search apparatus may adaptively adjust a safety step of the early-stop timepoint based on a weight, thereby adjusting the early-stop timepoint not to be advanced or delayed too rapidly. The search apparatus may adjust the early-stop timepoint in consideration of the simulation result (e.g., a position of the first learning epoch (First Success) 513 that is a success in the early stop and a position of the last learning epoch (Last Fail) 516 that is a failure in the early stop) in the dry run trial (e.g., the n-th trial 510). The example of adjusting the early-stop timepoint based on the result of simulation by the search apparatus is described with reference to FIG. 6.

FIG. 6 illustrates an example of adjusting an early-stop timepoint based on a simulation result in a dry run trial, according to one or more embodiments. Referring to FIG. 6, a diagram 600 shows simulation results 601 and 603 in a dry run trial.

In FIG. 6, SafetyStep is a basic step (magnitude) for shifting or adjusting the early-stop timepoint. The SafetyStep may be determined to be the greater of (i) a value obtained by dividing the number of learning epochs included in the dry run trial by a learning reference value (e.g., “100”) and (ii) “1”, for example, as expressed by SafetyStep=max(1, epoch/100).

SafetyGap indicates a shift limit such as an upper shift limit to increase the early-stop timepoint and/or a lower shift limit to decrease the early-stop timepoint. The SafeGap may prevent a current early-stop timepoint Stmp being adjusted from being shifted too much at once.

The SafeGapₙ₋₁ may exist in each of an increasing direction and a decreasing direction. SafeGapₙ₊₁ may correspond a trial immediately prior to a dry run trial. may correspond to a trial subsequent to the dry run trial. The initial value SafeGap₀ of the safe gap may be “1”.

The search apparatus may adjust the early-stop timepoint by the SafetyStep. The SafetyStep may be a step for increasing the SafeGap to adjust an early-stop timepoint for each dry run trial.

Sₜₘₚ corresponds to the current early-stop timepoint being adjusted in the dry run trial. Sₙ₋₁ corresponds to a preset early-stop timepoint in the trial immediately prior to the dry run trial. Sₙ₊₁ corresponds to an early-stop timepoint in the trial subsequent to the dry run trial, that is, an adjusted early-stop timepoint.

step_{gap} corresponds to a difference between a preset early-stop timepoint Sₙ₋₁ 610 and a first learning epoch (First Success Step) 620 that is a success with respect to an early stop among the learning epochs of the dry run trial. θ denotes a weight.

The search apparatus may adjust the early-stop timepoint in a different manner depending on whether the simulation result is a success or a failure with respect to the early stop.

Hereinafter, the example of adjusting the early-stop timepoint by the search apparatus when it is verified that the simulation result is a success of the early stop is described with reference to the simulation result 601. Further, the example of adjusting the early-stop timepoint by the search apparatus when it is verified that the simulation result is a failure of the early stop is described with reference to the simulation result 603.

The simulation result 601 shows a case in which an early stop is a failure (F) in a first learning epoch among the “16” learning epochs in the dry run trial, but the early stop is a success (S) in the remaining “15” learning epochs.

The search apparatus may increase the SafeGap for adjusting the early-stop timepoint, by a SafetyStep in each dry run trial. At this time, when an early-stop timepoint adjusted by the increased safety step is less than a safe gap corresponding to the preset early-stop timepoint, the search apparatus may set the adjusted early-stop timepoint to an adjusted SafeGap corresponding to the adjusted early-stop timepoint.

The search apparatus may adjust the early-stop timepoint in consideration of a difference step_{gap} between a first learning epoch (First Success Step) 620 that is a success of the early stop (among the learning epochs) and the preset early-stop timepoint Sₙ₋₁ 610. The search apparatus may adjust the current early-stop timepoint Sₜₘₚ by shifting the preset early-stop timepoint Sₙ₋₁ 610 according to a value obtained by applying a weight θ to the difference step_{gap}.

Alternatively, the search apparatus may change an early stop Sₙ₊₁ in a subsequent trial by simply increasing or decreasing the preset early-stop timepoint Sₙ₋₁ 610 by a safety step SafetyStep according to whether the simulation is a success or a failure.

When it is verified that the result of simulation is a success of the early stop, the search apparatus may change the early-stop timepoint Sₙ₊₁ in the subsequent trial by decreasing the preset early-stop timepoint Sₙ₋₁ 610 by the SafetyStep. The search apparatus may adjust the decreased early-stop timepoint to satisfy a condition that the decreased early-stop timepoint be positioned (set) behind a last learning epoch that is a failure of the early stop among the learning epochs.

Conversely, when it is verified that the result of simulation is a failure of the early stop, the search apparatus may change the early-stop timepoint Sₙ₊₁ in the subsequent trial by increasing the preset early-stop timepoint Sₙ₋₁ 610 by the SafetyStep. The search apparatus may adjust the increased early-stop timepoint to satisfy a condition that the increased early-stop timepoint is positioned (set) before a first learning epoch that is a success of the early stop (among the learning epochs).

When the current early-stop timepoint Sₜₘₚ is less than or equal to a SafeGapₙ₋₁ in an immediately preceding trial, the search apparatus may determine a position (a learning epoch) corresponding to a value obtained by subtracting the current early-stop timepoint Sₜₘₚ from the preset early-stop timepoint Sₙ₋₁ 610 to be the early-stop timepoint Sₙ₊₁ in the subsequent trial.

Conversely, when the current early-stop timepoint Sₜₘₚ is greater than the safe gap SafeGapₙ₋₁ in the immediately previous trial, the search apparatus may determine a position (a learning epoch) corresponding to a value obtained by subtracting the SafeGapₙ₋₁ in the immediately preceding trial from the preset early-stop timepoint Sₙ₋₁ 610 to be the early-stop timepoint Sₙ₊₁ in the subsequent trial.

When the current early-stop timepoint Sₜₘₚ is greater than the SafeGapₙ₋₁ in the immediately previous trial, the search apparatus may determine a position (a learning epoch) corresponding to a value obtained by adding a safety step SafetStop to the SafeGapₙ₋₁ in the immediately previous trial to be a SafeGapₙ₊₁ for a trial subsequent to the dry run trial. However, when the current early-stop timepoint Sₜₘₚ is less than the safe gap SafeGapₙ₋₁ in the immediately previous trial, the search apparatus may determine the current early-stop timepoint Sₜₘₚ to be the SafeGapₙ₊₁ for the trial subsequent to the dry run trial.

The example simulation result 603 is a case in which an early stop is a failure (F) in first to fourteenth learning epochs among the “16” learning epochs in the dry run trial, and then, the early stop is a success (S) in fifteenth and sixteenth learning epochs. In this case, the preset early-stop timepoint corresponds to an eighth learning epoch 630.

When the simulation result 603 is verified as a failure of the early stop, the search apparatus may adjust the preset early-stop timepoint (e.g., the eighth learning epoch 630) to a position subsequent to the fourteenth learning epoch 640, which is a last learning epoch (Last Fail Step) that is a failure of the early stop, among the learning epochs.

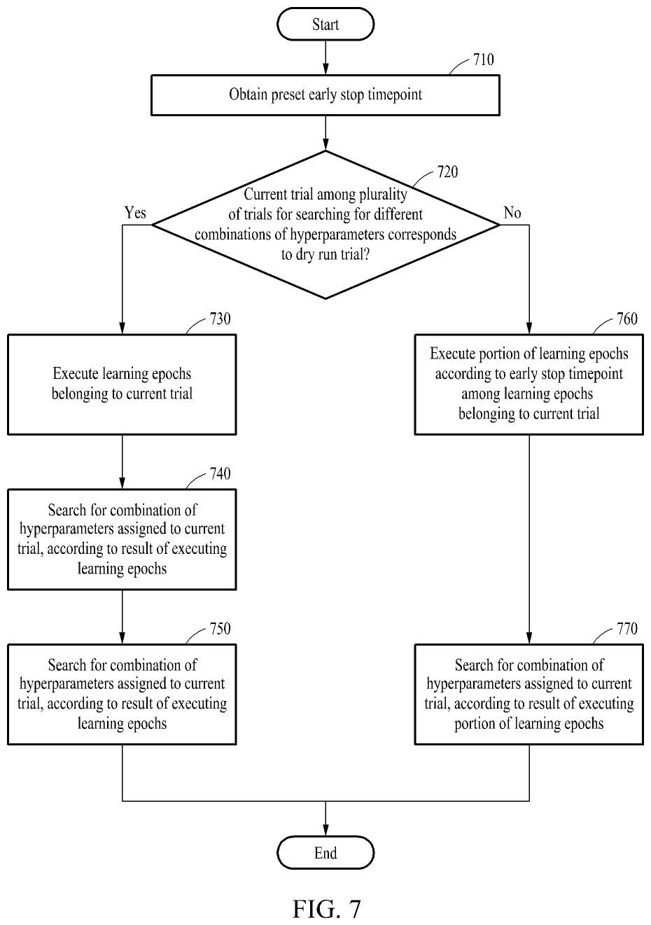

FIG. 7 illustrates an example method of searching for hyperparameters, according to one or more embodiments.

Referring to FIG. 7, a search apparatus may change an early-stop timepoint or search for hyperparameters through operations 710 to 770.

In operation 710, the search apparatus obtains a preset early-stop timepoint.

In operation 720, the search apparatus determines whether a current trial (among a plurality of trials for searching for different combinations of hyperparameters) corresponds to a dry run trial.

In response to a determination in operation 720 that the current trial corresponds to a dry run trial, the search apparatus may perform operations 730 to 750.

In operation 730, the search apparatus may execute all learning epochs belonging to the current trial.

In operation 740, the search apparatus may search for a combination of hyperparameters assigned to the current trial, according to a result of executing all the learning epochs in operation 730.

In operation 750, the search apparatus may change the early-stop timepoint by verifying whether an early stop by the combination of hyperparameters found in operation 740 is a success, in each of the learning epochs.

Conversely, in response to a determination in operation 720 that the current trial does not correspond to a dry run trial, the search apparatus may perform operations 760 and 770.

In operation 760, the search apparatus may execute a portion of epochs according to the early-stop timepoint among the learning epochs belonging to the current trial.

In operation 770, the search apparatus may search for a combination of hyperparameters assigned to the current trial, according to a result of executing the portion of learning epochs in operation 760.

FIG. 8 illustrates an example of performing an early-stop algorithm, according to one or more embodiments.

Referring to FIG. 8, a diagram 800 shows a process of receiving, by a search apparatus, a plurality of hyperparameters (e.g., objective metric 1 801 and objective metric 2 803) corresponding to an intermediate result of a neural network and performing an early-stop algorithm. The process of FIG. 8 may be referred to as Mode 1, where any of the hyperparameters may trigger an early stop.

The search apparatus utilizes multiple hyperparameters and thus, may determine whether to perform an early stop on different aspects. This may contribute to improving the performance of an early-stop algorithm, as in a multi-modal method that simultaneously uses voice, face, fingerprint, etc. for biometric authentication.

The plurality of hyperparameters may be transmitted in an N-tuple form (where there are N different parameters in the plurality of hyperparameters).

The search apparatus may determine whether to perform an early stop of the one of the hyperparameters (e.g., objective metric 1 801) by an algorithm A 810, and may determine whether to perform an early stop for another of the hyperparameters (e.g., second objective metric 2 803) by an algorithm A (or another algorithm) 820. The algorithm A 810 and the algorithm A (or other algorithm) 820 may be the same type of early-stop algorithm or may be different types of early-stop algorithms.

The search apparatus may stop the current learning when an early stop is determined according to either (i) a first determination result (Early StopRes1) of an early stop by the algorithm A 810 or (ii) a second determination result (Early StopRes2) of an early stop by the algorithm A (or other algorithm) 820, in operation 830. As described above, in Mode 1, when learning is stopped in response to a determination of the early stop in any one of the hyperparameters, the search apparatus may determine whether to perform an early stop quickly in terms of learning results by using multiple parameters, compared to using one hyperparameter.

FIG. 9 illustrates an example of performing an early-stop algorithm, according to one or more embodiments. The process of FIG. 9 may be referred to as Mode 2, where all or multiple hyperparameters trigger an early stop.

Referring to FIG. 9, a diagram 900 shows a process of receiving, by a search apparatus, a plurality of hyperparameters (e.g., an objective metric 1 901 and an objective metric 2” 903) corresponding to an intermediate result of a neural network and performing an early-stop algorithm.

The search apparatus utilizes multiple hyperparameters and thus, may determine whether to perform an early stop on different aspects. The search apparatus may receive a plurality of hyperparameters 901 and 903 transmitted in a N-tuple form (N hyperparameters, e.g., “2” in the examples of FIGS. 8 and 9).

The search apparatus may determine whether to perform an early stop of the objective metric 1 901 (a hyperparameter) by an algorithm A 910, and may determine whether to perform an early stop of the objective metric 2 903 (another hyperparameter) by an algorithm A (or other algorithm) 920. The algorithm A 910 and the algorithm A (or other algorithm) 920 may be the same type of early-stop algorithm or may be different types of early-stop algorithms.

The search apparatus may stop the current learning when an early stop is determined in both a first determination result (Early StopRes1) of an early stop by the algorithm A 910 and a second determination result (Early StopRes2) of an early stop by the algorithm A (or other algorithm) 920, in operation 930. As described above, when the early-stop algorithm determines an early stop of learning for all the hyperparameters (in Mode 2), learning time may increase, but a degradation of the learning performance of a neural network or neural network model due to the early stop may be reduced or prevented.

The search apparatus may select Mode 1 or Mode 2 according to the purpose of learning. For example, in the case of finding an optimal model in terms of feasibility review, the search apparatus may quickly search for an optimal model according to Mode 1. In the case of deriving a final model, the search apparatus may carefully (more finely) determine whether to perform an early stop according to Mode 2.

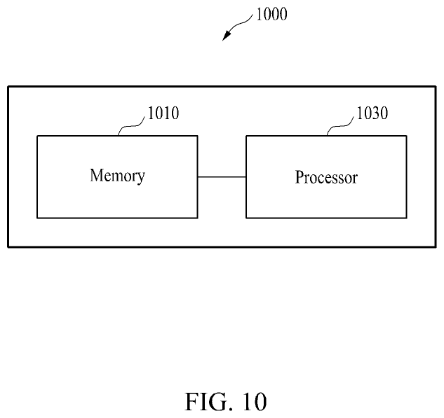

FIG. 10 illustrates an example of an apparatus for searching for hyperparameters, according to one or more embodiments. Referring to FIG. 10, a search apparatus 1000 may include a memory 1010 and a processor 1030.

The memory 1010 stores one or more instructions. Further, the memory 1010 may store a neural network used for learning. The memory 1010 may store at least one program and/or a variety of information generated in a processing process of the processor 1030. The memory 1010 may store, for example, an early-stop timepoint changed by the processor 1030, but is not necessarily limited thereto.

In addition, the memory 1010 may store a variety of data and programs. The memory 1010 may include a volatile memory or a non-volatile memory. The memory 1010 may include a high-capacity storage medium such as a hard disk to store a variety of data.

The processor 1030 is connected to the memory 1010, and obtains a preset early-stop timepoint and determines whether a current trial among a plurality of trials for searching for different combinations of hyperparameters corresponds to a dry run trial. The processor 1030 may perform the following operations in response to a determination that the current trial corresponds to a dry run trial. The processor 1030 executes learning epochs belonging to the current trial, and searches for a combination of hyperparameters assigned to the current trial according to a result of executing the learning epochs. The processor 1030 changes the early-stop timepoint by verifying whether an early stop by the found combination of hyperparameters is a success in each of the learning epochs.

The processor 1030 may execute the program and control the search apparatus 1000. Program codes to be executed by the processor 1030 may be stored in the memory 1010.

In addition, the processor 1030 may perform a technique corresponding to the at least one method described with reference to FIGS. 1 to 9. The processor 1030 may be, for example, a mobile application processor (AP), but is not necessarily limited thereto.

Alternatively, the processor 1030 may be a hardware-implemented electronic device having a physically structured circuit to execute desired operations. The desired operations may include, for example, codes or instructions included in a program. The hardware-implemented search apparatus 1000 may include, for example, a microprocessor, a central processing super sampling unit (CPU), a graphics processing super sampling unit (GPU), a processor core, a multi-core processor, a multiprocessor, an application-specific integrated circuit (ASIC), a field-programmable gate array (FPGA), and/or a neural processing unit (NPU), to name some examples.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of searching for hyperparameters for neural network learning, the method comprising:
obtaining a preset early stop point;
determining whether a current trial, among trials for searching for different combinations of hyperparameters, corresponds to a dry run trial;
in response to a determination that the current trial corresponds to a dry run trial:
executing learning epochs belonging to the current trial;
searching for a combination of hyperparameters assigned to the current trial according to a result of the executing of the learning epochs; and
changing the early stop point by based on whether an early stop with respect to a found combination of the hyperparameters is a success in each of the learning epochs.

2. The method of claim 1, further comprising:
in response to a determination that the current trial does not correspond to a dry run trial, executing a portion of epochs according to the early stop point among the learning epochs belonging to the current trial; and
searching for a combination of hyperparameters assigned to the current trial according to a result of the executing of the portion of learning epochs.

3. The method of claim 1, wherein the changing of the early stop point comprises:
simulating the early stop in each of the learning epochs; and
adjusting the early stop point based on a result of the simulating.

4. The method of claim 3, wherein the adjusting of the early stop point comprises:
increasing a safeguard gap for adjusting the early stop point by a safety step for each dry run trial; and
when an early stop point adjusted by the increased safeguard step is less than a safeguard gap corresponding to the preset early stop point, setting the adjusted early stop point to an adjusted safeguard gap corresponding to the adjusted early stop point.

5. The method of claim 3, wherein
the adjusting of the early stop point comprises adjusting the early stop point based on a difference between a first learning epoch that is a success with respect to the early stop among the learning epochs and the preset early stop point.

6. The method of claim 5, wherein
the adjusting of the early stop point comprises adjusting the early stop point by shifting the preset early stop point according to a value obtained by applying a weight to the difference.

7. The method of claim 3, wherein
the adjusting of the early stop point comprises:
based on the result of the simulating being a success with respect to the early stop, decreasing the early stop point by a safety step that is a step for increasing a safe gap for each dry run trial; and
in response to a verification that the result of the simulating is a failure of the early stop, increasing the early stop point by the safeguard step.

8. The method of claim 7, wherein
the safeguard step is determined to be the greater of 1 and a value obtained by dividing the number of learning epochs by a learning reference value.

9. The method of claim 7, wherein
the decreasing of the early stop point by the safety step comprises adjusting the decreased early stop point to satisfy a condition that the decreased early stop point is set behind a last learning epoch that is a failure with respect to the early stop among the learning epochs.

10. The method of claim 7, wherein
the increasing of the early stop point by the safety step comprises adjusting the increased early stop point to satisfy a condition that the increased early stop point is set before a first learning epoch that is a success of the early stop among the learning epochs.

11. The method of claim 3, wherein
the adjusting of the early stop point comprises, in response to a verification that the result of the simulating is a failure of the early stop, adjusting the early stop point to a setting subsequent to a last learning epoch that is a failure with respect to the early stop among the learning epochs.

12. The method of claim 1, wherein
the dry run trial is determined at a random interval or a regular interval for the trials.

13. A non-transitory computer-readable storage medium storing instructions that, when executed by a processor, cause the processor to perform the method of claim 1.

14. An apparatus for searching for hyperparameters for neural network learning, the apparatus comprising:
one or more processors;
a memory storing one or more instructions configured to cause the one or more processors to:
obtain a preset early stop point,
determine whether a current trial, among trials for searching for different combinations of hyperparameters, corresponds to a dry run trial,
in response to a determination that the current trial corresponds to a dry run trial:
execute learning epochs belonging to the current trial,
search for a combination of hyperparameters assigned to the current trial according to a result of the executing of the learning epochs, and
change the early stop point by verifying whether an early stop by a found combination of hyperparameters is a success in each of the learning epochs.

15. The apparatus of claim 14, wherein the instructions are further configured to cause the one or more processors to:
in response to a determination that the current trial does not correspond to a dry run trial:
execute a portion of epochs according to the early stop point among the learning epochs belonging to the current trial, and
search for a combination of hyperparameters assigned to the current trial according to a result of the executing of the portion of learning epochs.

16. The apparatus of claim 14, wherein the instructions are further configured to cause the one or more processors to:
simulate the early stop in each of the learning epochs, and
adjust the early stop point based on a result of the simulating.

17. The apparatus of claim 16, wherein the instructions are further configured to cause the one or more processors to adjust the early stop point by shifting the preset early stop point reflecting a value obtained by applying a weight to a difference between a first learning epoch that is a success of the early stop among the learning epochs and the preset early stop point.

18. The apparatus of claim 16, wherein the instructions are further configured to cause the one or more processors to:
in response to a verification that the result of the simulating is a success of the early stop, decrease the early stop point by a safety step that is a step for increasing a safeguard gap for each dry run trial, and
in response to a verification that the result of the simulating is a failure of the early stop, increase the early stop point by the safeguard step,
wherein the safeguard step is determined to be a greater of 1 and a value obtained by dividing the number of learning epochs by a learning reference value.

19. The apparatus of claim 16, wherein the instructions are further configured to cause the one or more processors to:
adjust the decreased early stop point to satisfy a condition that the decreased early stop point is set behind a last learning epoch that is a failure of the early stop among the learning epochs, and
adjust the increased early stop point to satisfy a condition that the increased early stop point is set before a first learning epoch that is a success of the early stop among the learning epochs.

20. The apparatus of claim 16, wherein the instructions are further configured to cause the one or more processors to, in response to a verification that the result of the simulating is a failure of the early stop, adjust the early stop point to a setting subsequent to a last learning epoch that is a failure of the early stop among the learning epochs.
